(19) United States
(12) Patent Application Publication
(10) Pub. No.: US 2010/0110105 A1
(43) Pub. Date: May 6, 2010

(54) METHOD, APPARATUS AND COMPUTER PROGRAM PRODUCT FOR PROVIDING SYNCHRONIZED NAVIGATION

(75) Inventors: Jari Pekka Kinnunen, Helsinki (FI); Brenda Castro Pelayo, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/263,296

(22) Filed: Oct. 31, 2008

(51) Int. Cl. G09G 5/00

(52) U.S. Cl. 345/629

(57) ABSTRACT

An apparatus for providing synchronized navigation may include a processor. The processor may be configured to provide for concurrent display of information related to a space dimension on a background layer and information related to a linear dimension on a foreground layer, wherein the foreground layer is provided as an overlay over at least a portion of the background layer. The processor may be additionally configured to provide for synchronized navigation of the foreground layer and the background layer. Associated methods and computer program products may also be provided.

### TECHNOLOGICAL FIELD

Embodiments of the present invention relate generally to information service technology and, more particularly, relate to a method, apparatus and computer program product for providing synchronized navigation.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. With the large amount of information available, information can be presented in different ways. Some types of information may be more meaningful when provided in accordance with a space dimension or physical space (e.g., a map). Other types of information may be more meaningful when provided in accordance with a linear dimension, or in other words in a certain order or arrangement (e.g., based on time) and displayed in a hierarchical manner (e.g., a list or a grid). Dedicated services and/or applications, such as, for example, location based services and/or applications may provide a combination of the aforementioned types of information such as, for example, a location-based message (e.g., a message that may include the identity of the creator of the message, a time of creation, and a location of creation), wherein the space dimension aspect and linear dimension aspect are both relevant.

However, the components (spatial dimension and linear dimension) of this combined type of information are separately provided for display on a graphical user interface (GUI), and as such, are separately and independently navigated. For example, the location of the creation of the message may be provided for display (e.g., map view) separately and independently from information regarding the identity of the creator of the message and the time of creation, which requires the repeated switch between the different views. Further, the navigation is either space-based or hierarchy-based, and navigating one dimension provides little to no information about the other dimension (e.g., a map does not provide any information related to chronological order). Moreover, switching between views complicates the reading and understanding of a map. Additionally, combining the visualization and/or navigation of these types of information (same time and same level of the screen) may be a difficult task that frustrates the user experience because the navigation may be confusing.

Accordingly, it may be desirable to provide an improved mechanism for navigating information related to a linear dimension, and seamlessly navigating corresponding information related to a space dimension.

### BRIEF SUMMARY

A method, apparatus and computer program product are therefore provided to enable the provision of a mechanism for synchronizing navigation. In some exemplary embodiments, information related to a linear dimension and information related to a space dimension may be simultaneously provided for display in an integrated GUI, one being an overlay over at least a portion of the other. As such, some exemplary embodiments of the invention may provide the linear navigation of information related to a linear dimension, and the seamless and automatic multidirectional navigation of corresponding information related to a space dimension.

In an exemplary embodiment, a method of providing synchronized navigation is provided. The method may include providing for concurrent display of information related to a space dimension on a background layer and information related to a linear dimension on a foreground layer, wherein the foreground layer is provided as an overlay over at least a portion of the background layer. The method may also include providing for synchronized navigation of the foreground layer and the background layer.

In another exemplary embodiment, a computer program product for providing synchronized navigation is provided. The computer program product includes at least one computer-readable storage medium having computer-executable program code instructions stored therein. The computer-executable program code instructions may include program code instructions for providing for concurrent display of information related to a space dimension on a background layer and information related to a linear dimension on a foreground layer, wherein the foreground layer is provided as an overlay over at least a portion of the background layer. Further, the computer-executable program code instructions may include program code instructions for providing for synchronized navigation of the foreground layer and the background layer.

In another exemplary embodiment, an apparatus for providing synchronized navigation is provided. The apparatus may include a processor. The processor may be configured to provide for concurrent display of information related to a space dimension on a background layer and information related to a linear dimension on a foreground layer, wherein the foreground layer is provided as an overlay over at least a portion of the background layer. The processor may further be configured to provide for synchronized navigation of the foreground layer and the background layer.

In yet another exemplary embodiment, an apparatus for providing synchronized navigation is provided. The apparatus may include means for providing for concurrent display of information related to a space dimension on a background layer and information related to a linear dimension on a foreground layer, wherein the foreground layer is provided as an overlay over at least a portion of the background layer. The apparatus may further include means for providing for synchronized navigation of the foreground layer and the background layer.

Embodiments of the invention may provide a method, apparatus and computer program product for employment, for example, in mobile environments. As a result, for example, mobile device users may enjoy an improved capability for synchronized multidirectional navigation via their respective computing devices.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a block diagram of a mobile terminal according to an exemplary embodiment of the present invention;

FIG. 3 illustrates a schematic block diagram of an apparatus for providing synchronized navigation according to an exemplary embodiment of the present invention;

FIG. 4 illustrates an example graphical representation of a synchronized navigation according to an exemplary embodiment of the present invention;

FIG. 5A illustrates another example of a graphical representation of a synchronized navigation according to an exemplary embodiment of the present invention;

FIG. 5B illustrates another example of a graphical representation of a synchronized navigation according to an exemplary embodiment of the present invention;

FIG. 6 illustrates a further example of a graphical representation of a synchronized navigation according to an exemplary embodiment of the present invention;

FIG. 7A illustrates another example of a graphical representation of a synchronized navigation according to an exemplary embodiment of the present invention;

FIG. 7B illustrates another example of a graphical representation of a synchronized navigation according to an exemplary embodiment of the present invention; and

FIG. 8 is a flowchart according to an exemplary method for providing synchronized navigation according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Additionally, “space dimension” or “spatial dimension” may be used interchangeably to refer to information related to location (e.g., coordinates, distance, proximity, and/or the like), physical and/or virtual space, and/or the like. Further, “linear dimension” may be used to refer to information related to the ordering of content (e.g., in a list) by time (chronological), alphabetical characters, recurrence, and/or the like. The terms “automatic” or “automatically” may be used interchangeably to refer to an action performed in an automated manner without user intervention. Additionally, the terms “post” or “posting” may be used interchangeably to refer to adding content as in a blog or microblog. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Embodiments of the present invention may be employed in the context of synchronizing multidirectional navigation. In this regard, for example, information related to the linear dimension may be provided in a foreground layer and information related to the space dimension may be provided in a background layer. In some examples, the foreground layer may be provided as a partially transparent overlay over at a least portion of the background layer. In other examples, the foreground layer may be provided may not be transparent (e.g., opaque) but may still be provided over at a least portion of the background layer. In some embodiments, the background layer may provide a map view that may be separately and independently navigated. The foreground layer may provide a selectable linear display of information such as, for example, a selection of information associated with one or more user contacts (a view of a selection of user contact(s) or a view of event(s) associated with user contact(s)). For example, the information associated with the one or more user contacts may comprise the identity of the one or more user contacts (e.g., name, screen name, and/or the like), one or more activities or events associated with the one or more user contacts and their time of occurrence (e.g., communications), one or more locations of the one or one more user contacts (e.g., last known location and time associated therewith, location of the occurrence of event(s) associated with a user contact and time associated therewith), and/or the like.

The selection of information associated with one or more user contacts may be ordered chronologically (by time). For example, the occurrence of an event associated with one or more users may be ordered from most recent to least recent, or the location associated with one or more user contacts may be ordered from most recently known location to least recently known location. A user may navigate the background layer and/or the foreground layer by various user input interface(s) and/or device(s) associated with or supported by the mobile device such as, for example, a keyboard, a joystick, a mouse, touch pad, and/or the like. The selection of information on the foreground layer may be navigated by, for example, scrolling up, down, left, or right, and the multidirectional navigation of the foreground layer may seamlessly and/or automatically provide the multidirectional navigation of the background layer. In some embodiments, the navigation of the background layer may be substantially simultaneous to the navigation of the foreground, while in other embodiments, the navigation of the background layer may be slightly delayed (e.g., half a second, a second, etc.). For example, a user may navigate and select information associated with a first user contact (e.g., an event or last known location) on the foreground layer which may cause the background layer to automatically and/or seamlessly zoom in/out, pan and/or jump to a first location, based at least in part on a location associated with the first user contact. A user may further navigate (e.g., scroll down) and select information associated with a second user contact (e.g., a user with an associated event or location occurring later in time than the first user contact) on the foreground layer which may cause the background layer to automatically and/or seamlessly zoom in/out, pan and/or jump to a second location from the previous location, based at least in part on the location associated with the second user contact. Additionally a user may cause the background layer to zoom in/out, pan and/or jump to the user's current location. Accordingly, the navigation of the foreground layer may affect the information provided on the background layer. As such, a user may visualize, comprehend and navigate information related to linear dimension and information related to spatial dimension in a seamless interaction between the navigation of the foreground layer and the navigation of the background layer on an integrated GUI, without having to switch between multiple views, thereby enhancing user experience.

Although exemplary embodiments of the present invention may be described with respect to a background layer providing a map view, other embodiments of the present invention may be equally applicable to a background layer comprising other content item(s) such as, for example, media (e.g., image or a selection of images), multimedia, application(s) and/or the like. The content items may provide information related to location, physical and/or virtual space, and/or the like. In this regard, the foreground layer may provide a selection of information associated with one or more user contacts. A user may navigate the foreground layer, as discussed above, which may cause the background layer to automatically and/or seamlessly zoom in/out, pan and/or jump to at least a portion of an image or a particular image associated with a user contact. Alternatively, the background layer may provide a map view and the foreground layer may provide a selection of images that may be arranged by time of creation. In this regard, a user may navigate the foreground layer and select a first image which may cause the background layer to zoom in/out, pan and/or jump to a location based at least in part on the location of creation of the image (e.g., the geographical location where the picture was taken). Similarly, the user may navigate and select a second image, and cause the background layer to zoom in/out, pan and/or jump to a second location based at least in part on the location of creation of the second image. Further, although exemplary embodiments of the present invention may be described with respect to order a selection of information on the foreground layer based at least in part on time, the selection of information may be ordered based on user preference(s) (e.g., alphabetical order, user contact relation to the user, etc.).

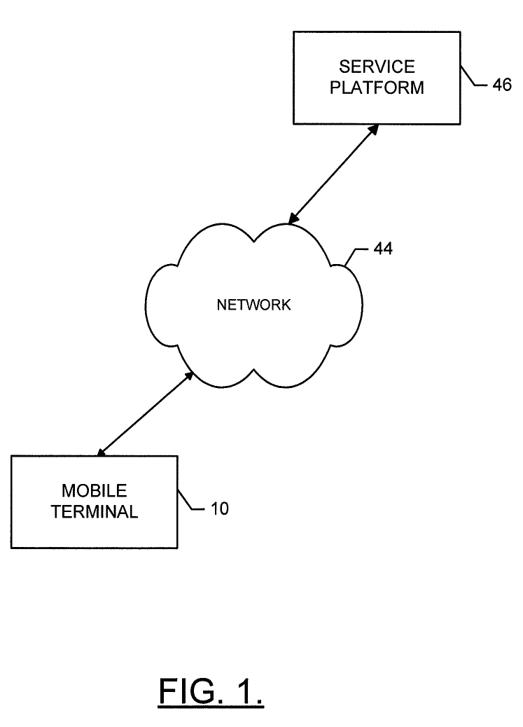

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) capable of communication with other devices via a network 44. In some cases, embodiments of the present invention may further include one or more additional communication devices and one or more network devices such as a service platform 46 with which the mobile terminal 10 may communicate to provide, request and/or receive information. In some embodiments, either or both of the mobile terminal 10 and the service platform 46 may include an apparatus 50 that may be configured to employ embodiments of the present invention. In this regard, it should be noted that the apparatus 50, which will be described in greater detail below, may be separately embodied at either one of the mobile terminal 10 or service platform 46 or at both of the mobile terminal 10 and the service platform 46 entirely or in a distributed manner. In an exemplary embodiment, if an instance of the apparatus 50 is embodied at both the mobile terminal 10 and the service platform 46, the apparatus 50 embodied at the mobile terminal 10 may comprise or execute a client application according to an exemplary embodiment, while the apparatus 50 embodied at the service platform 46 may include or comprise a server application according to an exemplary embodiment.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

The network 44 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 44. Although not necessary, in some embodiments, the network 44 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 may be in communication with each other via the network 44 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 via the network 44. By directly or indirectly connecting the mobile terminal 10 and other devices to the network 44, the mobile terminal 10 may be enabled to communicate with the other devices, for example, according to numerous communication protocols including Hypertext Transfer Protocol (HTTP) and/or the like, to thereby carry out various communication or other functions of the mobile terminal 10.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 44 and other devices by any of numerous different access mechanisms. For example, mobile access mechanisms such as wideband code division multiple access (WCDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 46 may be a device or node such as a server or other processing element. The service platform 46 may have any number of functions or associations with various services. As such, for example, the service platform 46 may be a platform such as a dedicated server (or server bank) associated with a particular information source or service (e.g., a location based service and/or a mapping service), or the service platform 46 may be a backend server associated with one or more other functions or services. As such, the service platform 46 may represent a plurality of different services or information sources. The functionality of the service platform 46 may be provided by hardware and/or software components configured to operate in accordance with known techniques for the provision of information to users of communication devices. However, some of the functionality provided by the service platform 46 may be information provided in accordance with embodiments of the present invention.

In an exemplary embodiment, the service platform 46 may represent a source for information associated with a service that may be provided to the mobile terminal 10 in accordance with embodiments of the present invention. As such, for example, the mobile terminal 10 may run a client application configured to communicate with a corresponding server function at the service platform 46. The client application may be configured to enable the registration to the service by a user of the mobile terminal 10, sending and receiving of a request to and from one or more other users to be added as contact(s) on the service, uploading of contacts(s) from the mobile terminal 10 or another device (e.g., remote server), the activation and deactivation of location and/or content (e.g., messages, media, etc.) sharing, while the server function may enable the processing of these various requests and functionalities. The server platform 46 may then provide information associated with one or more user contacts and their associated locations to the mobile terminal 10 for display, and for seamless and/or automatic navigation. In some examples, a seamless and/or automatic may be provided between a current location (e.g., current location of the user of mobile terminal 10 or current location associated with a first user contact) to a location associated with a second user contact based at least in part on the last known or shared location of the second user contact. In other examples, a seamless and/or automatic navigation may be provided to a default location (e.g., home, a location frequented by the second user contact, etc.) associated with the second user contact, if no known location is available or last known location is not recent.

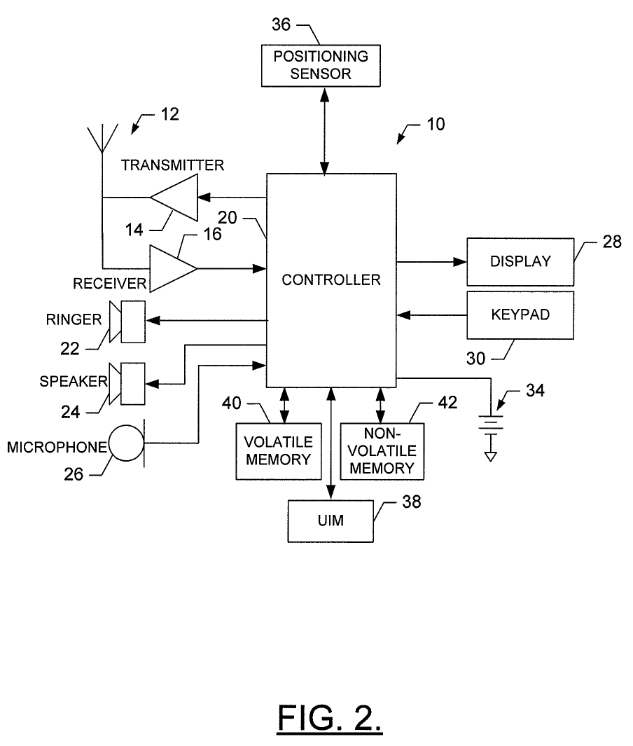

FIG. 2 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processing element, that may provide signals to and receive signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 20 may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40 and/or non-volatile memory 42.

In some cases, the mobile terminal 10 may further include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point. In some cases, the positioning sensor 36 may include components enabling a determination of mobile terminal 10 position based on triangulation with respect to signals received from various sources or other techniques. In some examples, the location of a mobile terminal 10 or a position relative to a reference point, such as a destination or start point, may be manually determined. Information from the positioning sensor 36 or manually determined may then, in some cases, be communicated to a memory of the mobile terminal 10 or to another memory device (e.g., associated with the server platform 46) to be stored as a position history or location information.

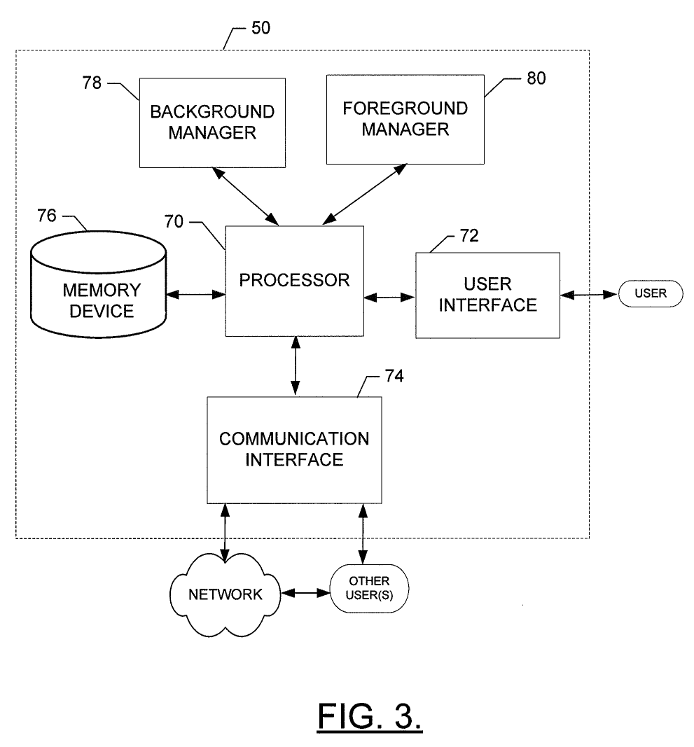

FIG. 3 illustrates a schematic block diagram of an apparatus for enabling the provision of synchronized navigation according to an exemplary embodiment of the present invention. An exemplary embodiment of the invention will now be described with reference to FIG. 3, in which certain elements of an apparatus 50 for providing synchronized multidirectional navigation are displayed. As indicated above, the apparatus 50 of FIG. 3 may be employed, for example, on the service platform 46 or on the mobile terminal 10. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the service platform 46 or the mobile terminal 10), by a plurality of devices in a distributed fashion (e.g., split between the service platform 46 and the mobile terminal 10) or by devices in a client/server relationship (e.g., the mobile terminal 10 and the service platform 46). Furthermore, it should be noted that the devices or elements described below may not be mandatory and thus some may be omitted in certain embodiments. Additional elements could also be added.

Referring now to FIG. 3, an apparatus for providing synchronized multidirectional navigation is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information (e.g., information associated with user contact(s), preference(s) and/or profile(s) of user, etc., and/or the like), maps, information about various locations, services, etc., and/or the like) and/or media content. The information associated with user contact(s) may comprise identity(ies) of user(s), shared and unshared location(s) of user(s) and time associated with the location(s), shared and unshared event(s) associated with user(s) and time associated with the event(s) (e.g., a communication, the location (e.g., geographical) of creation of the communication, the time of creation), other shared or unshared information (e.g., media, applications, and/or the like), and/or the like.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied at a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a background manager 78 and a foreground manager 80. As such, the background manager 78 and the foreground manager 80 may in some cases each be separate devices, modules, or functional elements. However, in other embodiments, some or all of the background manager 78 and the foreground manager 80 may be embodied within a single device, module, or functional element, such as the processor 70. The background manager 78 and the foreground manager 80 may each be any means such as a device or circuitry embodied in hardware, software or a combination of hardware and software (e.g., processor 70 operating under software control) that is configured to perform the corresponding functions of the background manager 78 and the foreground manager 80, respectively, as described below. For example, the background manager 78 and the foreground manager 80, individually or in combination, may include means for providing for concurrent display of information related to a space dimension on a background layer and information related to a linear dimension on a foreground layer, wherein the foreground layer is provided as an overlay over at least a portion of the background layer and means for providing for synchronized navigation of the foreground layer and the background layer. In some embodiments, communication between any or all of the background manager 78 and the foreground manager 80 may be conducted via the processor 70. However, some or all of the background manager 78 and the foreground manager 80 may alternatively be in direct communication with each other.

In some embodiments, the background manager 78 may be configured to generate and/or display a map of a particular area. The map displayed may be a background layer. Moreover, the map displayed may include location(s) of user(s) and/or user contact(s), information associated with user(s) and/or user contact(s) (images, avatar, icons, communications, identifiers, other content, and/or the like), landmarks, roads, buildings, points of interest, service points or numerous other geographical features. The background manager 78 may be configured to provide a multidirectional navigation of the map independently or based at least in part on information received from the foreground manager 80. In this regard, for example, the background manager may be configured to cause a zoom in/out, pan and/or jump to a desired location independently or based at least in part on a location associated with information selected by the foreground manager 80. Similarly, the background manager 78 may be configured to cause the permanent or temporary display of identifiers or icons of user contact(s), geographical features, and/or other information, independently or based at least in part on information received from the foreground manager 80.

In some embodiments, the background manager 78 may be further configured to include routing services. For example, the background manager 78 may be configured to determine one or more candidate routes between a current or starting location and a destination or ending location. As such, for example, the background manager 78 may provide route guidance based at least in part on multiple locations associated with one or more particular user(s) or user contact(s), or provide route guidance to a particular service point, landmark, building, point of interest, etc., using operational information such as driving time, driving distance, fuel consumption, battery consumption, etc. The background manager 78 may incorporate into the map display various ones of the geographical features and other supplemental information about a particular service point (e.g., an identifier or icon indicative of the availability of a particular product or service (e.g., gasoline or food)).

In some embodiments, the foreground manager 80 may be further configured to generate and/or display a selectable list of information associated with one or more user contact(s). The list or selection of information may be provided in a hierarchical organization on a foreground layer overlaid over at least a portion of the map generated or displayed by the background manager 78. In some embodiments, the foreground layer may be provided as a partially transparent overlay. The foreground manager 80 may be configured to cause the foreground layer to be permanently or continuously displayed, or displayed for only a predetermined amount of time (e.g., some time before and/or after the navigation of the background layer). The information associated with the user contacts may comprise user contact identification (e.g., name, screen name, etc.), location of the user contact(s) (e.g., last known or shared location) and the time associated with the location, event(s) associated with the user contact(s) (e.g., communications) and the time associated with the event(s) (e.g., time of creation), shared content, and/or the like. As used herein, “event” or “activity” may be used interchangeably to refer to creating a communication on the apparatus 50. As used herein, “communication” may be used to refer to a message or a posted message. In some embodiments, a type of message (e.g., message post) may be associated with a creator of the message, the content thereof, and the time of posting and/or creation. Another type of message (e.g., a location-stamped post) may also be associated with a creator of the message, the content thereof, the location (e.g., geographical) of the user contact (e.g., creator) when the message was created, and the time of posting and/or creation. In some embodiments, the foreground manager 80 may cause a location validity attribute to be associated with the messages. For example, a user may associate a predetermined location or a geographical area surrounding or otherwise associated with the location wherein the associated message may be accessed (e.g., viewable or visible). As such, the foreground manager 80 may cause the navigation of the background layer to a location based at least in part on the location of creation of the message and/or the location validity attribute associated with the message.

The foreground manager 80 may be configured to cause the selection of information to be ordered and arranged based at least in part on a time associated with the location(s) associated with the user contact(s) or with the event(s) associated with the user contact(s). In this regard, the foreground manager 80 may be configured to provide the foreground layer as a plurality of layers. For example, a first layer may display user contact(s) and the information associated with their locations, and a second layer may display user contact(s) and event(s) associated with the user contact(s). The foreground manager 80 may be configured to provide a multidirectional navigation of the foreground layer synchronized with the multidirectional navigation of the background layer (e.g., the map). As such, a user may navigate the selection of information by scrolling up or down the selection. As a particular user contact information is selected, the foreground manager 80 may cause the background manager 78 to navigate the background layer to a location based at least in part on a location associated with the selected user contact by, for example, zooming in/out, panning and/or jumping to the location. A user may also navigate the selection of information by moving left to right or right to left. In this regard, the user may navigate between the multiple layers of the foreground layer. The foreground manager 80 may also be configured to associate an attribute indicative of relevant information to a user contact (e.g., newness of information for each of the selection of information associated with the user contact(s), a type of the user contact, and/or the like). Similarly, the background manager 78 may also be configured to associate an attribute indicative of relevant information with the selected information on the foreground layer (e.g., newness of information for each information corresponding to a selected information on the foreground layer, a type of selected information, and/or the like). The content manager 78 may also be configured to periodically monitor the location of a user or user contact based at least in part on the use of the client application of the server platform 46. For example, positioning data (e.g. positioning sensor 36 data, cellid, etc.) may be monitored more periodically (e.g., every two seconds) if the application is being actively used (e.g., foreground use), or less periodically (e.g., every three, fifteen or thirty minutes) if the application is being passively used (e.g., background use). A new position data may be recorded and/or updated more periodically (e.g., every two seconds) on a mobile terminal 10, and less periodically on the server platform 46 (e.g., every three, fifteen or thirty minutes), thereby allowing the location of a user or user contact to be accessed by other users or user contacts.

In some embodiments, information originally provided on the foreground layer may be provided on the background layer, and the information originally provided on the background layer may be provided on the foreground layer. Therefore, the position of the foreground layer and the background may be swapped. In some examples, the swap may occur based at least in part on receiving a user input (e.g., depressing of an input on the mobile, clicking on or otherwise selecting an indicator on the display, etc.). In some examples, the background manager 78 and/or the foreground manager 80 may receive the user input and effectuate the change (e.g., a swap of position of information presented on the display). As such, for example, the background manager 78 may manage the information on the foreground layer and the foreground layer may manager information on the background layer. The navigation of the background layer may therefore continue to affect the navigation of the foreground layer, as discussed above. In other examples, the swap may automatically occur based at least in part on a user preference. The position of the foreground layer may be arbitrary, manual based at least in part on receiving a user input, or predefined and/or automatic.

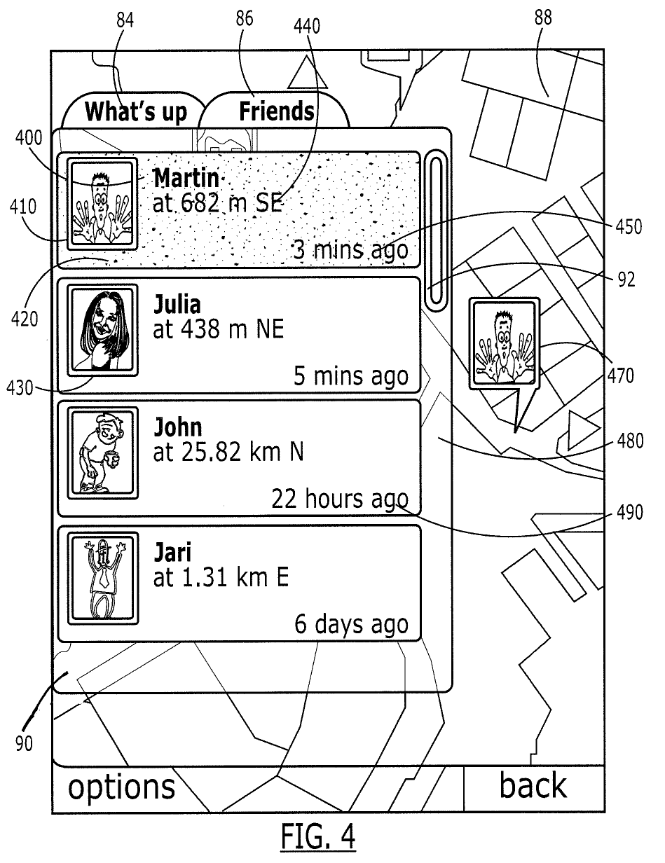

FIG. 4 illustrates an example graphical representation of a synchronized navigation according to an exemplary embodiment of the present invention. As can be seen from FIG. 4, an overlay 90 may be disposed over at least a portion of map 88, and the overlay 90 may be partially transparent. The overlay 90 may comprise two layers that may be identified by separate tabs (a first tab 84 and a second tab 86) and a scroll bar 92 (e.g., for navigating a selection of information associated with user contacts). In some embodiments, the user may customize the overlay 90 to include additional layers or tabs. As indicated above, a user may navigate back and forth between the two tabs by, for example, depressing a left or right cursor button. In FIG. 4, the second tab 86 (e.g., “Friends” tab) may be selected and may provide a selection of information associated with a user contact(s) such as, for example, user contact(s) identification(s), last known location 440 of the user contact(s), and/or a time reference 450 associated with the location (e.g., how long ago the location was recorded and/or updated). The user contact(s) identification(s) may comprise a user name or screen name 400 and a representation 410 of the user contact such as, for example, an icon, avatar, actual photograph of the user contact, and/or the like. In some embodiments, an information relevance attribute may be associated with the user contact representation 410 which, for example, may indicate time information (whether the location and/or an event associated with the user contact is recent), a type of the user contact (e.g., family, friend, co-worker), and/or the like. For example, a frame 430 may be placed around the user contact representation. For example, a first color of the frame 430 may indicate that the location and/or event associated with the user contact is recent, while a second color may indicate that the location and/or event associated with the user contact is old or not recent. The color of the frame 430 may include gradations to represent a range of time values. As such, a user may readily identify an active user contact, select the user contact on the foreground layer, and be presented with location of the user contact on a map, through a seamless navigation of the background layer to the location of the user contact, as discussed above. In some example, a user contact may be active (e.g., using/accessing service platform 46 using a mobile terminal 10) but may have de-activated the location sharing feature. As such, the user contact may be appear inactive and the time associated with the last known location may be considerable (e.g., time reference 490).

The selection of information associated with the user contact(s) may be ordered or arranged based at least in part on the time associated with the location. As such, the user contact with the most recently last known location may be displayed first. For example, as illustrated in FIG. 4, Martin is first listed in the selection because his last known location is the most recently recorded location (i.e., three minutes ago). As shown, the location 440 of the user contact displayed may be based at least in part on the current location of the user of the mobile terminal. The selected user contact 420 may be identified by associating an attribute (e.g., color) with the selected user contact different from the attribute associated with the non-selected user contact. Upon selection, the background layer may zoom in/out, pan and/or jump to the location of the selected user attribute and the representation 470 associated with or corresponding to the user contact may be activated on the map 88 (e.g., highlighted, change of color), and placed at the exact location or a location approximate to the last known location of the selected user contact. As such, in some examples, the area displayed in the background layer may correspond to the location associated with the selected user contact, the center point of the area being based at least in part on the location associated with the selected user contact. In some embodiment the user contact representation 470 of the user contact may always be provided in the background layer, although not always activated and/or not visible to the user (e.g., outside a viewable area of the mobile terminal display). As such, a directional indicator (e.g., an arrow) may be provided on the display (e.g., proximate to the edge of the display) pointing to the direction of the location of the user contact representation 470. The indicator may be associated with attributes indicative a location of the user contact representation 470 and a relevance of information associated with the user contact (e.g., when or how long was the user contact's location was recorded/updated, when or how long ago was a message or comment posted by the user contact, etc.), as further explained in U.S. patent application entitled Method, Apparatus and Computer Program Product for Providing Expedited Navigation filed concurrently with this application. In some examples, user contact representations 410 and 470 may be the same, while in other examples, they may be different.

As indicated above, the position of the foreground layer and that of the background layer may be swapped. For example, the placement of the overlay 90 and the map 88 may be swapped. In some example, the overlay 90 may be distributed over the entire or a considerable portion of the display, on a background layer. The dimension of the map 88 may be reduced and the map 88 may be provided on the foreground layer. In some embodiment, the map 88 may be provided as a transparent overlay.

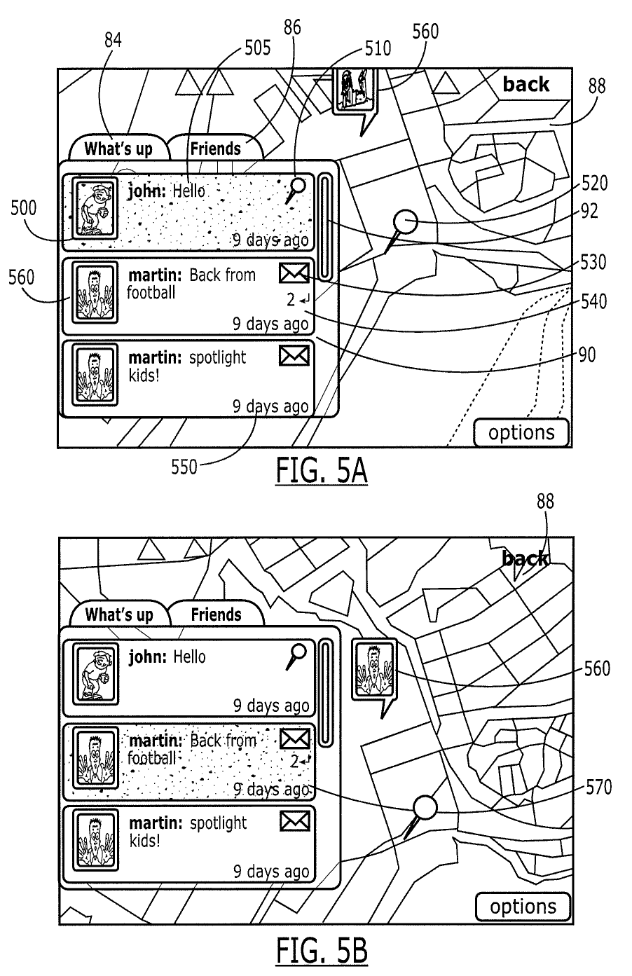

FIG. 5A illustrates another example graphical representation of a synchronized navigation according to an exemplary embodiment of the present invention. As shown in FIG. 5A, the first tab 84 (e.g., “What's up” tab) may be selected and may provide a selection of information associated with a user contact(s) such as, for example, user contact(s) identification(s), a communication from the user contact 505, an icon (e.g., 510 or 530) or other representation indicative of an event associated with the user contact(s), and a time reference 550 associated with the event (e.g., how long ago the event was recorded and/or updated). The selection of information associated with the user contact(s) may be ordered or arranged based at least in part on the time associated with the event (e.g., time of creation of the event or storage thereof, or time of most recent comment on the event or storage thereof). As such, the user contact with the most recent event may be displayed first. As mentioned above, an indication of an event associated with the user contact(s) may be provided. A first embodiment of the indication of an event, pin 510, may correspond to a location-stamped message, and a second embodiment, envelope 530, may correspond to a message post, both of which may be stored on a memory device such as, for example, memory device 76.

A location-stamped post may comprise the identity of the user or user contact creating the message, the time of posting or creation, the content of the message drafted by the user or user contact, and the location (e.g., geographical) of the user contact (e.g., creator) when the message was created. For example, the user contact may generate a location-stamped post to comment on a current location (e.g., recommending a restaurant, a particular site). In some examples, a location-stamped post may quickly be generated with a generic or default message (e.g., “I'm here”) to indicate the current location of the user to other user(s), without the user drafting a specific message. In some examples, the location associated with a location-stamped post may be different from the last known location associated with the user or user contact. For example, a user may create a location-stamped post at a certain location and thereafter move to a subsequent location. If the user or user contact has activated the location sharing feature, the subsequent location may be recorded, and as such become the last known location of the user or user contact. A message post may comprise the identity of the user or user contact creating the message, the time of posting or creation, and the content of the message drafted by the user or user contact. Users may provide comments (e.g., indicated by element 540) on location-stamped posts and message posts, which comments may also be stored in a memory device such as, for example, memory device 76. For example, as illustrated in FIG. 5A, two comments have been made to Martin's message post. The location-stamped post or message post with the most recent comment may be moved to the top of the selection of information associated with the user contacts. The content of the location-stamped posts, message posts, and the comments thereto may be accessible. For example, a first click on a selected post or comment may open the post or comment for review, and a second click may cause the background layer to navigate to the location associated with the post or comment.

A user may thus navigate the foreground layer to select a user contact with an associated pin 510 (in this example, John, as illustrated by element 500). As such, the background layer or map 88 may seamlessly and/or automatically navigate to the location associated with pin 510 by zooming in/out, panning and/or jumping to the location associated with the location-stamped post pin 510. The pin 510 may then be activated (e.g., highlighted, change of color) and/or made visible on the background layer. As shown, the area provided may also include the user contact representation 560 of a different user contact, without providing the representation of the user contact that created the location-stamped post because that user contact may have moved to a different location. In some examples, upon selecting different information (e.g., different location-stamped post or a message post) associated with the same or a different user contact, the previous pin 510 may no longer be visible, as illustrated in FIG. 5B. In this regard and referring now to FIG. 5B, another example graphical representation of a synchronized navigation according to an exemplary embodiment of the present invention is illustrated. As shown in FIG. 5B, a user may select a different user contact (in this example, Martin, as illustrated by element 570). As such, the pin post 510 may disappear from the background layer or map 88, and the background layer or map 88 may seamlessly and/or automatically navigate to the location associated with the selected user (e.g., last known location) by zooming in/out, panning and/or jumping to the last known location associated with the selected user contact. The user contact representation 560 of the selected user contact may be brought into focus and activated, and the placement of the user contact representation 560 on the map may be based at least in part on the location of the selected user contact. In some cases, navigating to a location associated with the event (e.g., message post and/or location-stamped post) may comprise navigating to the location of creation of the event and/or the location validity associated with the event, as discussed above.

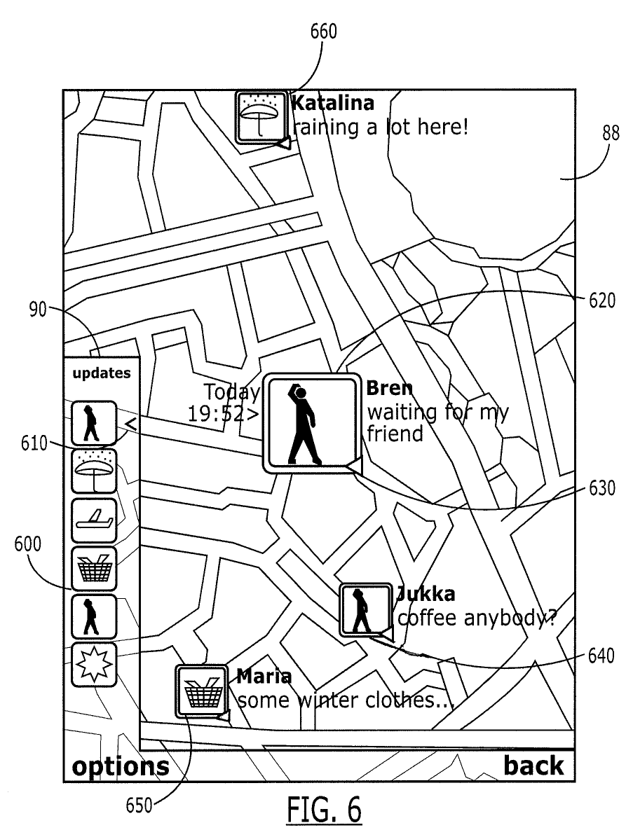

FIG. 6 illustrates a further example of a graphical representation of a synchronized navigation according to another embodiment of the present invention. As shown in FIG. 6, a different embodiment of overlay 90 may be disposed over at least a portion of map 88, and the overlay 90 may be partially transparent. The overlay 90 may provide a selection of information 600 associated with user contact(s). The selection of information may comprise a selection of objects, icons, avatar, image, or other representations indicative of, for example, an action (e.g., walking, flying, shopping, etc.), a weather condition, a mood, a condition, and/or the like associated with the user contact. A user or user contact may create a communication (e.g., write or post a message) and the message may be stored on a memory device such as, for example, memory device 76, along with the time of creation the message. The user or user contact may also chose to associate an object or representation which may be descriptive of the action, the weather condition, the mood, the condition, and/or the like. As such, the selection of information may be ordered based at least in part on the time of creation of the communication. The overlay 90 may also include an indicator 610 to identify a selected user contact. Additionally, a relevance information attribute (e.g., a color, etc.) may be associated with the selected information associated with the user contact. The user may thus navigate the overlay 90 to select an object associated with a user contact. As such, the background layer or map 88 may be seamlessly and/or automatically navigated to the last known location associated with the selected user contact, and an object may be provided approximately or exactly at the last known location of the selected user contact indicative of the last known location. In this regard, the background layer or map 80 may activate (e.g., highlighted, enlarged, color may be changed) the object associated with the selected user contact.

The background layer or map 88 may provide for display of a plurality of objects associated with various user contact(s) which may be placed at the last known location(s) of the user contact(s). Each object may be provided, for example, with the name or screen name of the user contact, a message from the user contact, and an indicator of whether the user contact is active or inactive. For example, object 660, associated with a user contact named Katalina, may be descriptive of a raining condition, and the message from Katalina may indicate the same. For example, the object associated with a selected user contact (e.g., object 620) may be highlighted and may include the time of creation of the message. The object may also include an indicator 630 providing information relating to the status of the selected user contact (e.g., active or inactive).

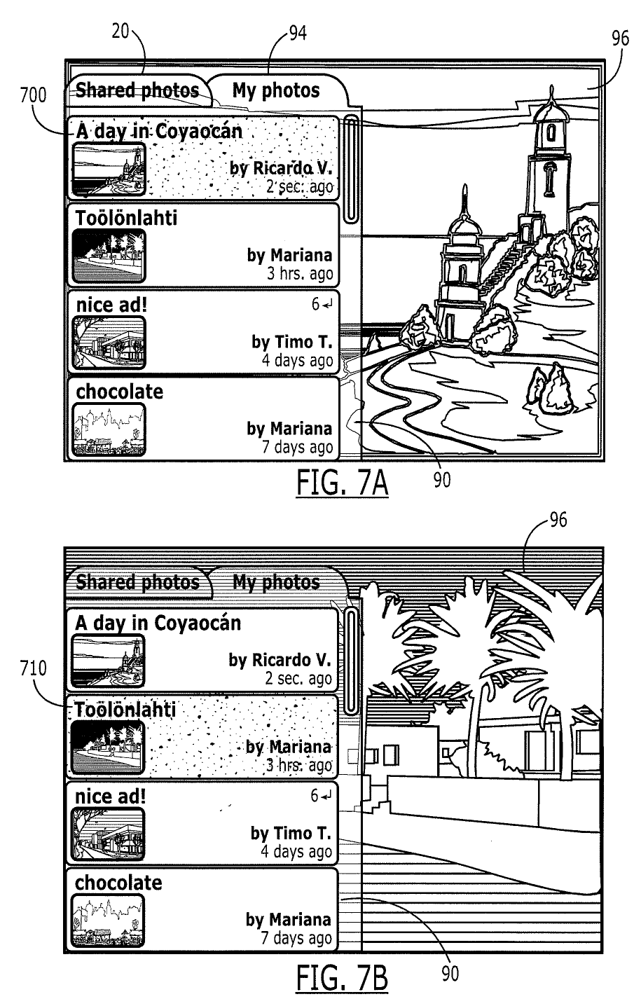

FIG. 7A illustrates another example of a graphical representation of a synchronized navigation according to a different embodiment of the present invention. As shown, the background layer 96 may provide a content item (e.g., an image). The content item may provide information related to location, physical and/or virtual space, and/or the like. As shown, overlay 90 may comprise two layers, a first layer 92 (“Shared photos”) and a second layer 94 (“My photos”). The overlay 90 may provide a selection of information associated with user contact(s) including a content item (e.g., an image or thumbnail thereof). In this regard, a user may desire to share a content item (e.g., a media, multimedia, application, and/or the like) with other users. As such, the user may post the media and cause the content to be stored on a memory device, for example, on memory device 76 (along with the time associated with its time of post or creation and the name or user name), and activate a sharing functionality to allow the content to be shared. Users may also comment on shared content and as such, the time of the comment may be associated with the shared content. Similarly to the previous embodiment, the content of comments may be accessible. Accordingly, the selection of information provided on the overlay 90 may be ordered by the time associated with the content (e.g., time of post or creation and/or time of comment). The selection of information on the overlay 90 may also include a description of the content, the name or screen name of the user contact, and a time reference associated with the creation of the content (e.g., how long ago the content was created and/or posted), and/or comment indicator, as described above. The background layer may provide the actual content (e.g., an image). For example, a user may navigate the overlay 90 and select information associated with a particular content item (e.g., element 700). The background layer 96 may be seamlessly and/or automatically navigated to select and provide the content corresponding to the selected information. Referring now to FIG. 7B, the user may then navigate the overlay 90 and select information associated with a different content item (e.g., element 710). The background layer 96 may be seamlessly and/or automatically navigated to provide a different content (e.g., another image) corresponding to the selected information.

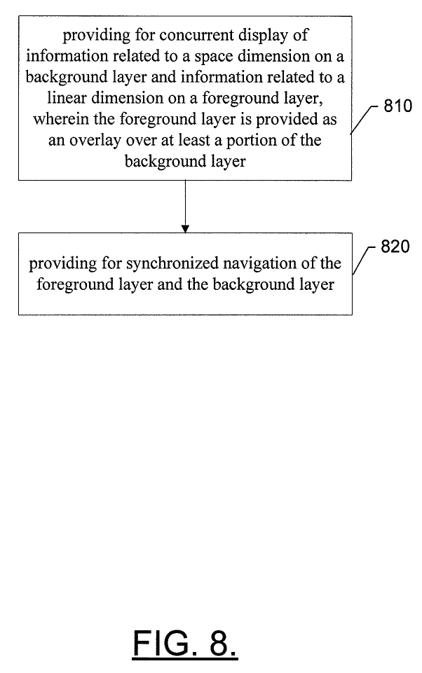

FIG. 8 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, service platform or other apparatus employing embodiments of the present invention and executed by a processor in the mobile terminal, service platform or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing synchronized navigation as illustrated, for example, in FIG. 8 may include providing for concurrent display of information related to a space dimension on a background layer and information related to a linear dimension on a foreground layer, wherein the foreground layer is provided as an overlay over at least a portion of the background layer at operation 810. The method may further include providing for synchronized navigation of the foreground layer and the background layer at operation 820.

In some embodiments, certain ones of the operations above may be modified or further amplified as described below. It should be appreciated that each of the modifications or amplifications below may be included with the operations above either alone or in combination with any others among the features described herein. In this regard, for example, providing for synchronized navigation at operation 820 may include selecting at least one content item from the foreground layer and automatically providing for display of corresponding content within the background layer. In some examples, providing for display of the information related to the linear dimension in a foreground layer at operation 810 may include providing for display of the information related to the linear dimension in a multilayered foreground layer. In some examples, providing for concurrent display of information related to a space dimension on a background layer and information related to a linear dimension on a foreground layer, wherein the foreground layer is provided as an overlay over at least a portion of the background layer at operation 810 may include providing the foreground layer as an overlay over at least a portion of the background layer by transparency and/or by distribution. Alternatively or additionally, the method may include comprising providing for independent navigation of the background layer. In other examples, the method may include accessing content associated with a map to provide information related to the space dimension.

In some embodiments, the method may include comprising accessing information associated with at least one user contact to provide the information related to the linear dimension, wherein the information associated with at least one user contact is selected from the group consisting of user contact identification, location, communication, and time of an activity associated the at least one user contact. In some cases, providing for display of the information related to the linear dimension may include providing for a selection of information associated with at least one user contact ordered based at least in part by a time of occurrence of an activity associated with the at least one user contact. In other cases, providing for a selection of information associated with at least one user contact may include providing timing information for an activity associated with the at least one user contact.

In an exemplary embodiment, an apparatus for performing the method of FIG. 8 above may comprise a processor (e.g., the processor 70) configured to perform some or each of the operations (810-820) described above. The processor may, for example, be configured to perform the operations (810-820) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 810-820 may comprise, for example, the processor 70, respective ones of the background manager 78 and the foreground manager 80, or an algorithm executed by the processor for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for concurrent display of information related to a space dimension on a background layer and information related to a linear dimension on a foreground layer, wherein the foreground layer is provided as an overlay over at least a portion of the background layer; and
providing for synchronized navigation of the foreground layer and the background layer.

2. The method of claim 1, wherein providing for synchronized navigation comprises selecting at least one content item from the foreground layer and automatically providing for display of corresponding content within the background layer.

3. The method of claim 1, further comprising providing for independent navigation of the background layer.

4. The method of claim 1, further comprising accessing content associated with a map to provide information related to the space dimension.

5. The method of claim 1, further comprising accessing information associated with at least one user contact to provide the information related to the linear dimension, wherein the information associated with at least one user contact is selected from the group consisting of user contact identification, location, communication, and time of an activity associated the at least one user contact.

6. The method of claim 5, wherein providing for display of the information related to the linear dimension comprises providing for a selection of information associated with at least one user contact ordered based at least in part by a time of occurrence of an activity associated with the at least one user contact.

7. The method of claim 6, wherein providing for a selection of information associated with at least one user contact comprises providing timing information for an activity associated with the at least one user contact.

8. The method of claim 1, wherein providing for display of the information related to the linear dimension in a foreground layer comprises providing for display of the information related to the linear dimension in a multilayered foreground layer.

9. A computer program product comprising at least one computer-readable storage medium having computer-executable program code instructions stored therein, the computer-executable program code instruction comprising:
program code instructions for providing for concurrent display of information related to a space dimension on a background layer and information related to a linear dimension on a foreground layer, wherein the foreground layer is provided as an overlay over at least a portion of the background layer; and
program code instructions for providing for synchronized navigation of the foreground layer and the background layer.

10. The computer program product of claim 9, wherein program code instructions for providing for synchronized navigation includes program code instructions for selecting at least one content item from the foreground layer and automatically providing for display of corresponding content within the background layer.

11. The computer program product of claim 9, further comprising program code instructions for providing an independent navigation of the background layer.

12. The computer program product of claim 9, further comprising program code instructions for accessing content associated with a map to provide information related to the space dimension.

13. The computer program product of claim 9, further comprising program code instructions for accessing information associated with at least one user contact to provide the information related to the linear dimension, wherein the information associated with at least one user contact is selected from the group consisting of user contact identification, location, communication, and time of an activity associated the at least one user contact.

14. The computer program product of claim 13, wherein program code instructions for providing for display of the information related to the linear dimension includes program code instructions for providing for a selection of information associated with at least one user contact ordered based at least in part by a time of occurrence of an activity associated with the at least one user contact.

15. The computer program product of claim 14, wherein program code instructions for providing for a selection of information associated with at least one user contact includes program code instructions for providing timing information for an activity associated with the at least one user contact.

16. The computer program product of claim 9, wherein program code instructions for providing for display of the information related to the linear dimension in a foreground layer includes program code instructions for providing for display of the information related to the linear dimension in a multilayered foreground layer.

17. An apparatus comprising a processor configured to:
provide for concurrent display of information related to a space dimension on a background layer and information related to a linear dimension on a foreground layer, wherein the foreground layer is provided as an overlay over at least a portion of the background layer; and
provide for synchronized navigation of the foreground layer and the background layer.

18. The apparatus of claim 17, wherein the processor is configured to provide for synchronized navigation comprises the processor configured to select at least one content item from the foreground layer and automatically providing for display of corresponding content within the background layer.

19. The apparatus of claim 17, wherein the processor is further configured to provide for independent navigation of the background layer.

20. The apparatus of claim 17, wherein the processor is further configured to access content associated with a map to provide information related to the space dimension.

21. The apparatus of claim 17, wherein the processor is further configured to access information associated with at least one user contact to provide the information related to the linear dimension, wherein the information associated with at least one user contact is selected from the group consisting of user contact identification, location, communication, and time of an activity associated the at least one user contact.

22. The apparatus of claim 21, wherein the processor is configured to provide for display of the information related to the linear dimension by providing for a selection of information associated with at least one user contact ordered based at least in part by a time of occurrence of an activity associated with the at least one user contact

23. The apparatus of claim 22, wherein the processor is configured to provide for a selection of information associated with at least one user contact by providing timing information for an activity associated with the at least one user contact.

24. The apparatus of claim 17, wherein the processor is configured to provide for display of the information related to the linear dimension in a foreground layer by providing for display of the information related to the linear dimension in a multilayered foreground layer.

25. An apparatus comprising:
means for providing for providing for concurrent display of information related to a space dimension on a background layer and information related to a linear dimension on a foreground layer, wherein the foreground layer is provided as an overlay over at least a portion of the background layer; and
means for providing for synchronized navigation of the foreground layer and the background layer.

26. The apparatus of claim 25, wherein means for providing synchronized navigation comprises means for selecting at least one content item from the foreground layer and automatically providing for display of corresponding content within the background layer
